(19) United States
(12) Patent Application Publication
(10) Pub. No.: US 2011/0299671 A1
(43) Pub. Date: Dec. 8, 2011

(54) Doorcellphone

(76) Inventor: Volodymyr Sukhov, Haifa (IL)

(21) Appl. No.: 12/804,083

(22) Filed: Oct. 7, 2010

Related U.S. Application Data
(60) Provisional application No. 61/396,791, filed on Jun. 3, 2010.

(51) Int. Cl. H04M 11/00

(52) U.S. Cl. 379/90.01

(57) ABSTRACT

The main idea is to simplify an intercom-to-cell phone system and to make it cheaper for the consumer by using a conventional phone line to connect an intercom to a designated cell phone.

The intercom itself consists of a call button, microphone and speaker that wired to a connector. A controller will call a designated cellular phone when the call button is pressed.

If the controller location is close enough, the door part of the system does not need any battery or power supply. Since a regular phone line is used, the controller does not need a transmitter and receiver, and it makes the system cheaper.

The system is simple, affordable and ready for use after minimal installation and entering a cellular phone number in the memory of the controller. Programming is as simple as for a regular phone set.

### CROSS-REFERENCE TO RELATED APPLICATIONS

Not Applicable

### BACKGROUND OF THE INVENTION

There are many types of wireless intercom systems that use transmitters and receivers to interconnect an intercom and handsets. The radius of coverage provided by such systems is restricted, and the devices are expensive.

Using cellular phones allows to communicate with an entrance intercom, and/or check security sensors, fire alarms and home installed microphones and video cameras to monitor your home or office from a distance.

A further object of this invention is the connection of the intercom to a regular phone line to make the system simpler and thus more affordable.

The system does not need transmitters, receivers, complicated power supplies and converters.

### SUMMARY OF THE INVENTION

In accordance with the invention, an intercom station includes regular parts of an entrance door intercom like a push button, microphone, speaker, and optional video camera.

The controller part of the system connects to a regular phone line and can be activated by the push button to enable interactive communication between the intercom and designated cell phone via the ground phone line using regular phone service.

The controller part will be activated in response to incoming telephone call from a designated cellular phone to check the system, monitor premises via audio or/and video devices.

The controller will send an SMS or special signal to designated cell phones in case of an emergency if any signal from security sensors, fire alarms, and/or other optional devices.

### DESCRIPTION OF THE DRAWING

FIG. 1 shows an embodiment of the intercom unit of the system and the control unit.

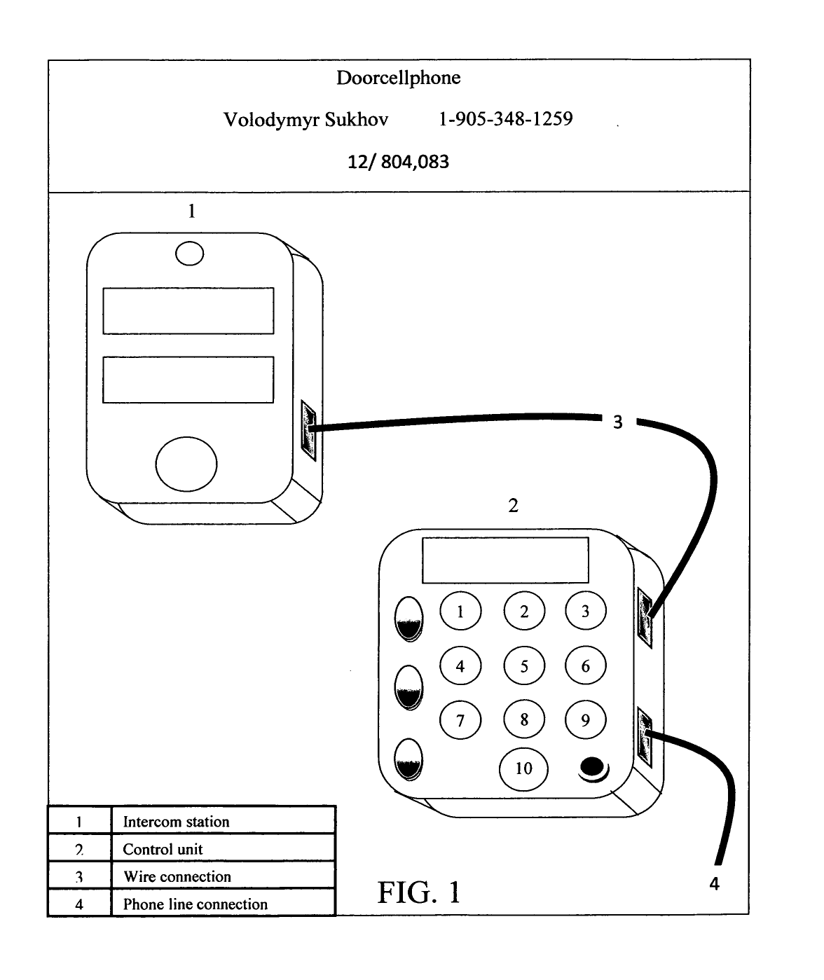

FIG. 2 shows more detailed block diagram of the embodiment of the intercom station and controller with recommended parts.

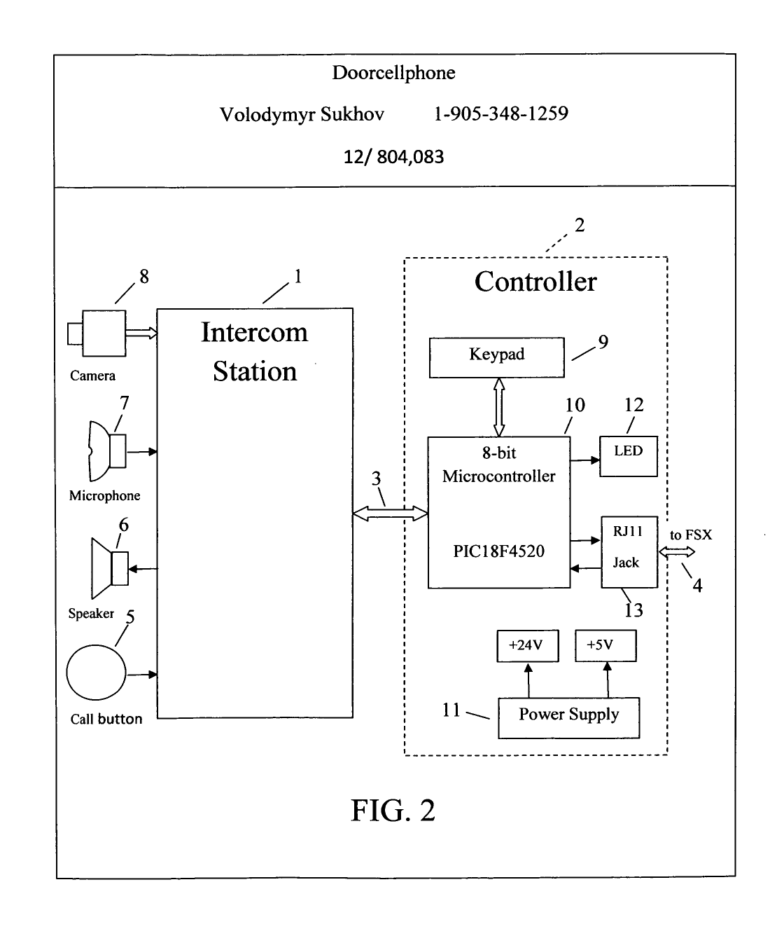

### DESCRIPTION OF THE INVENTION

An entry intercom and controller system, comprising:
The intercom part 1 of the system consists of a push button 5, microphone 7, speaker 6, and video camera 8 (optional)
Door Station is flush-panel or surface mountable
Tough, weather-resistant and vandal-resistant construction
The controller 2 includes a microcontroller 10, keypad 9, phone jack RJ-11 13, power supply/battery 11, and green LED 12 for indication

In accordance with the invention, the controller of the intercom system is connected to a regular phone line, so the device is simple and inexpensive
The intercom (intercommunication device) calls designated cellular phones in case of an emergency or when somebody pressed the call button 5
Pressing the call button 5 is similar to calling a number from the memory of a regular phone set
Power supplies from a telephone jack 13, battery or/and specially designed power supply 11
The intercom 1 connects to the controller 2 as an input/output part of the system
The controller has a keypad 9 for programming of the device to memorize phone numbers
You can check what is going on at the place from a cell phone from a distance by calling there and listening in via the microphone 7, watching via the camera 8
Designated cell phones can send control signals to check the system (programmable, optional)
The controller also can have some extra inputs and outputs to connect to external sensors, recording devices, the Internet and/or Ethernet

What is claimed is:

1. An entry intercom and controller system that uses a regular phone line—connected to a wall phone jack—to call a cellular phone when a door call button is pressed. A microphone and speaker allow the intercom to communicate with a designated cell phone. No transmitter-receiver devise is needed. Communication from a distance. Simple design.
